(19) United States
(12) Patent Application Publication
(10) Pub. No.: US 2006/0161478 A1
(43) Pub. Date: Jul. 20, 2006

(54) System, method and computer program product for currency redemption in loyalty reward programs

(76) Inventors: Jessica Turner, Alexandria, VA (US); Robert Greenberg, Glen Allen, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/326,575

(22) Filed: Jan. 6, 2006

Related U.S. Application Data
(60) Provisional application No. 60/641,439, filed on Jan. 6, 2005.

(51) Int. Cl. G06Q 30/00

(52) U.S. Cl. 705/14

(57) ABSTRACT

A loyalty and redemption system, method and computer program product includes a selectable connection to a loyalty program hosting server site on a distributed communication network from a merchant site on the network. A customer can access the loyalty program hosting server site through the merchant site. At the loyalty program hosting server site, a user interface page enables the customer to enroll and prioritize reward programs. The loyalty program hosting server site is adapted to calculate a conversion value for the enrolled reward programs and a total currency value. The customer is provided with a rewards card including the calculated currency value, and the loyalty program hosting server site is adapted to deduct currency value from the rewards card based on the prioritized reward programs.

This application claims priority from U.S. provisional application Ser. No. 60/641,439, filed Jan. 6, 2005, the contents of which are incorporated by reference.

### BACKGROUND OF THE INVENTION

1. Field of the Invention

The present invention relates to a loyalty reward and redemption system, method and computer program product.

2. Description of the Background Art

Conventional electronic bartering systems allow users to aggregate reward points into an account for redeeming products and services offered over the Internet. Such systems allow users to use reward points for products or services other than those typically offered by the issuing entity, and for products or services offered by merchants other than the issuing entity. Some systems even allow users to purchase points traded in by other users, such that points are redistributed without incurring a transaction directly with the issuing entity.

Postrel discloses such a system in U.S. Pat. Nos. 6,829,586 and 6,820,061, which relate to a system and method for operating a reward points accumulation and redemption program. A user earns reward points from a plurality of independent reward points issuing entities, with each tracking the user's earned reward points in a user reward point account stored on a rewards server (e.g., frequent flyer or credit card loyalty account). A trading server accumulates some or all of the user's earned reward points from the reward servers and credits the accumulated points into a single reward exchange account associated with the user. The user may then select an item for purchase in exchange for a subset or all of the reward points. The user may have the selected items delivered to the user by performing a purchase request by various means, such as over the Internet, dialing a toll free number for placing an order, or any other means of placing an order that will accept payment from the system.

In such prior art systems, a user cannot designate the order in which his/her reward points will be used. For example, older reward points may be used last (instead of first), newer reward points may be used first (instead of last), frequent flyer points may be used first instead of frequent dining or frequent rental points, etc. Further, the reward points in the prior art systems are not converted to a cash value that can be stored on a rewards credit card and used like a major credit or store card. Finally, a credit card, bank card, savings account or checking account cannot be linked to a rewards credit card to cover overage expenses in the prior art systems.

Thus, a need exists in the art for a system, method and computer program product that overcome the above deficiencies of the prior art.

### SUMMARY OF THE INVENTION

The present invention provides such a desired system, method and computer program product. In one aspect, the present invention provides a loyalty and redemption method. A selectable connection to a loyalty program hosting server site on a distributed communication network from a merchant site on the network is provided whereby a customer can access the loyalty program hosting server site through the merchant site. At the loyalty program hosting server site, a user interface page enables the customer to enroll and prioritize reward programs. The loyalty program hosting server site calculates a conversion value for the enrolled reward programs and a total currency value. The customer is provided with a rewards card including the calculated currency value, and currency value is deducted from the rewards card based on the prioritized reward programs.

In another aspect of the present invention, a loyalty and redemption system is provided. One or more merchant servers include a communication server module for communication over a distributed communication network. One or more client-user devices include a client application module for communication over the network. The client application module interfaces with the communication server module over the network. A loyalty program hosting server is operatively connected to the network. The client-user device accesses the loyalty program hosting server via the merchant server. The loyalty program hosting server contains a user interface page that enables the customer to enroll and prioritize reward programs. The loyalty program hosting server calculates a conversion value for the enrolled reward programs and a total currency value. The customer is provided a rewards card including the calculated currency value, and currency value is deducted from the rewards card based on the prioritized reward programs.

In yet another aspect of the present invention, a loyalty program hosting server is operatively connected to a distributed communication network, wherein the client-user device accesses the loyalty program hosting server via the merchant server. The loyalty program hosting server contains a user interface page that enables the customer to enroll and prioritize reward programs. The loyalty program hosting server calculates a conversion value for the enrolled reward programs and a total currency value.

In yet another aspect of the present invention, a computer program embodied on a computer readable medium comprises a computer code segment for enabling a user to enroll and prioritize reward programs using an application program module that runs on a loyalty program hosting server. The loyalty program hosting server calculates a conversion value for the enrolled reward programs and a total currency value.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a functional block diagram of the architecture for a system, method and computer program product according to the present invention.

FIG. 2 shows a process that illustrates the basic flow of events that occur when a user enrolls in the loyalty program of the present invention.

FIG. 3 shows a process that illustrates the basic flow of events that occur when a user makes a purchase transaction using the present invention.

FIG. 4 shows a process that illustrates the basic flow of events that occur when a user initiates a reward exchange using the present invention.

### DETAILED DESCRIPTION OF THE PREFERRED EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, enterprise technologies, middleware, development interfaces, hardware, etc. in order to provide a thorough understanding of the present invention. However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, enterprise applications, operating systems, enterprise technologies, middleware, development interfaces, and hardware are omitted so as not to obscure the description of the present invention.

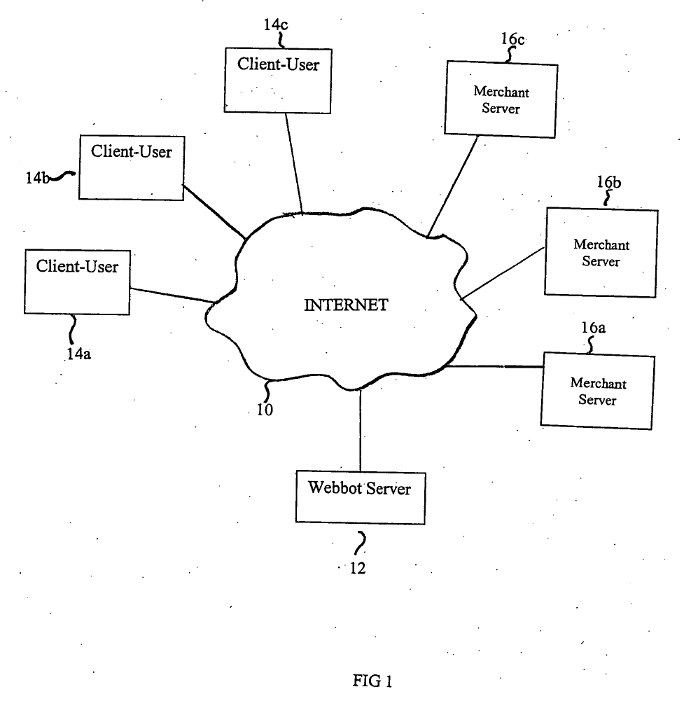

With reference to FIG. 1, the invention contemplates a plurality of client-user devices 14a-14c, a plurality of merchant servers 16a-16c, and a webbot server 12, each operatively connected to a distributed communication network 10 such that each server or client is able to communicate and exchange data with any other server or client. According to an exemplary embodiment of the present invention, the distributed communication network 10 comprises the Internet. However, any type of distributed communication network, such as a wide-area network, Intranet, public network, private network, or the like, may be used in conjunction with the principles of the present invention.

The client-user devices 14a-14c may include a client application module, which may be, for example, a web browser. For simplicity, throughout the specification, the term “client-user device 14” will be referenced. However, the terms “client-user devices 14a-14c” and “client-user device 14” are interchangable and implies one or more user devices. The client-user device 14 may be any type of computing device that allows a user to interactively browse the Internet 10 via the web browser. The web browser consists of client software that runs on the client-user device 14 and displays web pages on the World Wide Web. The web browser displays information on the client-user device 14 by interpreting HTML code that is used to build web pages on the World Wide Web.

The merchant servers 16a-16c, as illustrated in FIG. 1, include a communication server module, an application program server module, and a database server module. For simplicity, throughout the specification, the term “merchant server 16” will be referenced. However, the terms “merchant servers 16a-16c” and “merchant server 16” are interchangable and implies one or more merchant servers. The merchant server 16 may be comprised of one or more computers that are capable of functioning as servers, running software to host a web site, such as the web site for Trilegiant Loyalty Solutions (i.e., “www.trilegiantloyalty.com”).

In an exemplary embodiment of the present invention, the merchant server 16 includes a communication server device for implementing the communication server module. The communication server device running the communication server module acts as a web server and communicates with the client-user device 14 (and the webbot server 12) over the Internet 10.

The merchant server 16 includes an application program server device for implementing the application program server module. The application program server module includes a software application for allowing users to, for example, enroll and participate in a merchant reward program, a super loyalty program, etc. Reward programs are programs offered by a merchant to reward a consumer for purchasing the merchant's services or products. Generally, reward points are issued to the consumer for participating in the merchant's reward program.

The merchant server 16 includes a database server device for implementing the database server module. The database can store information associated with each user and merchant information relating to reward programs. It will be appreciated by those skilled in the art that any information can be stored.

The webbot server 12, as illustrated in FIG. 1, includes a communication server module, an application program server module, and a database server module. The webbot server 12 may be comprised of one or more computers that are capable of functioning as servers, running software to host a web site. The webbot server 12 includes a communication server device for implementing the communication server module, an application program server device for implementing the application program server module, and a database server device for implementing the database server module.

The communication server device of the webbot server 12 running the communication server module acts as a web server and communicates with the client-user device 14 and the merchant server 16 over the Internet 10. In the preferred embodiment, the webbot server 12 can request and pull user information (e.g., information relating to a participant of a reward program, etc.) and merchant information (e.g., information relating to currency conversion, issued points, etc.) from the merchant server 16 hosting a reward program.

The application program server module of the webbot server 12 includes a software application that allows a user to, for example, register reward programs, set-up a customer account-portfolio, view an account, check balance(s), etc. Merchants can be in the same market, such as the hotel industries, or the merchants can be in different markets, such as hotel, retail and airline industries, etc. The consumer can earn reward points such as frequent flyer miles, frequent car rental, frequent dining, frequent hotel, or frequent auction, etc., for participating in the merchant's reward program.

The database server module device of the webbot server 12 can store information (e.g., statistics, enrolled reward programs, priority designations, total value of each reward currency, total cash value, etc.) associated with each user of the system. It will be appreciated by those skilled in the art that any information can be stored.

According to an exemplary embodiment of the present invention, a user enters a URL such as “www.trilegiantloyalty.com” to access the merchant server 16 using the web browser (e.g., Microsoft's Internet Explorer) of the client-user device 14. The web browser sends the URL request using HTTP to the Internet 10, and the communication server module of the merchant server 16 receives the request. A web page is sent to the web browser and is displayed on the client-user device 14.

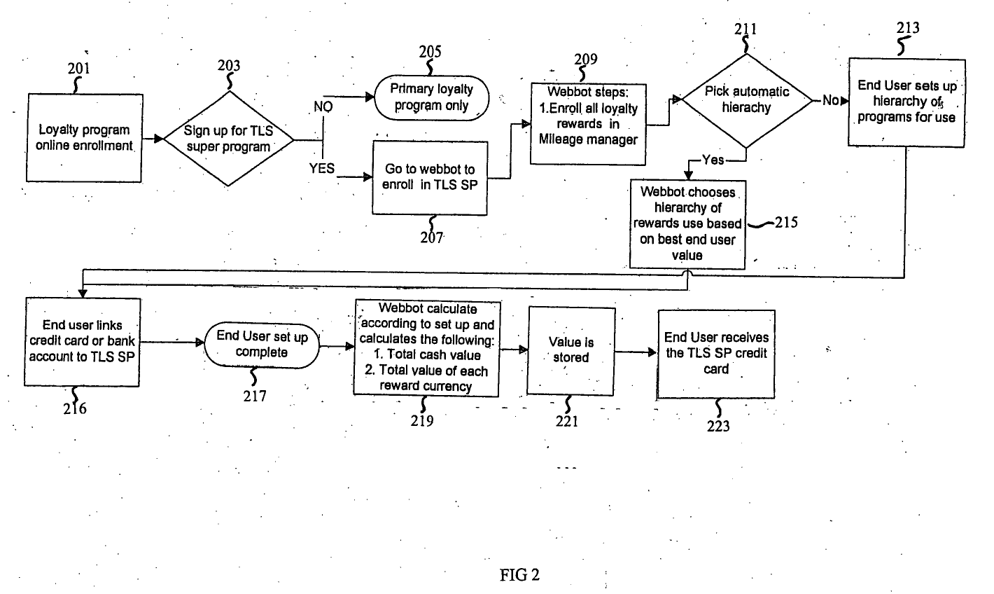

Referring to FIG. 2, a user can enroll in a super loyalty program (in step S203) using the web page displayed on the client-user device 14. A hyperlink, link, banner or the like may be placed on the web page to allow the user to access the super loyalty program. The user may or may not be a participant in a merchant's reward program to enroll in the super loyalty program. A super loyalty program provides the user with advanced features and options, as will be discussed below, that are not offered in a standard reward program. It will be appreciated by those skilled in the art that a consumer can automatically be enrolled in the super loyalty program for participating in a merchant's standard reward program, etc.

In the preferred embodiment, a user enrolls in a merchant's reward program (in step S201) and is given an option to sign up for the super loyalty program (in step S203). This may be desired if a user is a participant in more than one merchant's reward program. If the user does not elect to sign up for the super loyalty program in step S203, the user will only be enrolled in the merchant's standard reward program (step S205). However, if the user does elect to sign up for the super loyalty program in step S203, the user will be brought to a webbot site (step S207) running on the webbot server 12. Preferably, the webbot site is a web page. It will be appreciated by those skilled in the art that the webbot site can run directly from the merchant server 16. At the webbot site, the user sets up his/her account-portfolio by performing a series of steps.

At step S209, the user can enroll all of his/her reward programs that he/she is a participant or member of. The order in which the reward points (from the enrolled reward programs) will be used is determined in step S211. If the user desires, he/she can manually identify the order in step S213. For example, if a user desires to redeem for hotel stays, he/she would select Restaurant A, Restaurant B, Merchant C, Merchant A . . . before Hotel C and Hotel D.

Alternatively, the webbot system can automatically identify the order in which the reward points will be used in accordance to a hierarchy/program logic in step S215. The program logic is based on program rules of the individual reward program values. The user confirms the suggestion(s) in the hierarchy. The system will then prioritize the points according to the best value for the user and the pre-selected redemption category(s). The redemption categories include, but are not limited to, air, hotel, travel packages, rental cars, merchandise, gift certificates, cash, etc.

In this embodiment, for example, if a user wants to redeem for hotel stays, he/she would select “hotel” as the redemption category. The webbot system would then look at the user's enrolled reward programs (i.e., Hotel A, Hotel B, Airline A, Rental Car A), and determine which reward program offers the most value in hotel redemption. The system would prioritize the reward programs accordingly; and select Airline A and Rental Car A (before Hotel A and Hotel B) to be used for cash or air purchases because Hotel A and Hotel B would have the highest hotel redemption value.

At step S216, the user can link a credit/bank card, checking account or savings account to his/her portfolio to ensure that the user's rewards credit card has sufficient funds when making a purchase transaction or a reward exchange. The user can enter a credit card number and/or checking/savings account number, and authorize the webbot system to withdraw funds from the user's account(s). It will be appreciated by those skilled in the art that this feature can be implemented using conventional means.

The user completes the set up of his/her account-portfolio at step S217. It will be appreciated by those skilled in the art that other set-up features and options may be available to the user, and the present invention is not limited to the above set-up features and options. At any time, the user may exit out of the super loyalty program and all entries will be saved in the database associated with the user.

According to the predefined parameters set by the user, all enrolled reward programs and points are aggregated. A value for each reward program's currency and a total cash value of the user's portfolio is calculated in step S219. The calculation will be based on a currency conversion (e.g., world cash currency). For example, each reward program will have a value(s) assigned to its “reward points” (currency), and the value will be equivalent to the value of another reward program (i.e., $10 US dollars=$8.83 CAD, 10 Airline A miles=7 Hotel A points). The conversion value(s) will be set by the issuing entity (e.g., the value for Airline A is set by Airline A, and the value for Hotel A is set by Hotel A), and the issuing entity determines the currency conversion value with other reward programs.

The calculated value is then stored in the database in step S221, and the reward currency can be used as cash or other reward currency.

At step S223, the user is sent via conventional means a rewards credit card that has a cash value that was calculated in step S219. The rewards credit card can be used as if it was a major credit card, store credit card or the like, as will be discussed in detail below. It will be appreciated by those skilled in the art that the rewards credit card can be sent to the user prior to the calculation step (step S219). For example, the rewards credit card can be sent to a user after the user completes the set-up process (step S217).

Each time a user enrolls a new reward program, a calculation (e.g., a total value of reward currency and total cash value) is performed. In the preferred embodiment, additional cash value is added to the rewards credit card by conventional means. In alternative embodiments, a rewards credit card can be issued monthly, bimonthly, quarterly, etc., if new reward programs are enrolled during these periods. Preferably, a user is sent one rewards credit card after the initial enrollment of his/her reward programs, and additional value is added to the rewards credit card when additional reward programs are enrolled.

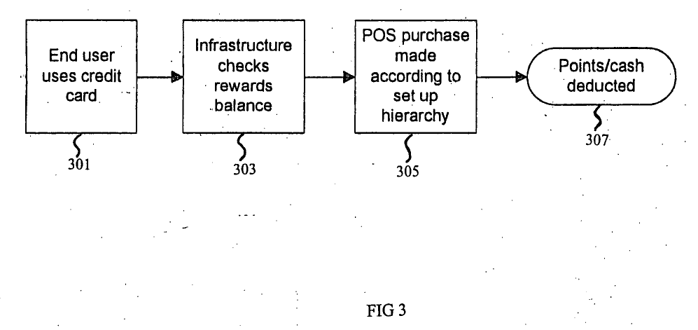

FIG. 3 is a flow chart illustrating the basic flow of events that occur when a user makes a purchase transaction using the present invention. Referring now to the steps shown in FIG. 3, in step S301, when a user makes a purchase transaction using his/her rewards credit card at a merchant POS, on-line merchant location, etc., the balance of the rewards credit card is checked/verified (step S303) using conventional means. According to the user set-up and priority selections (step S305), as discussed above, points and/or cash are deducted from the balance of the rewards credit card (step S307). The new balance is stored to the rewards credit card (and in the database associated with the user).

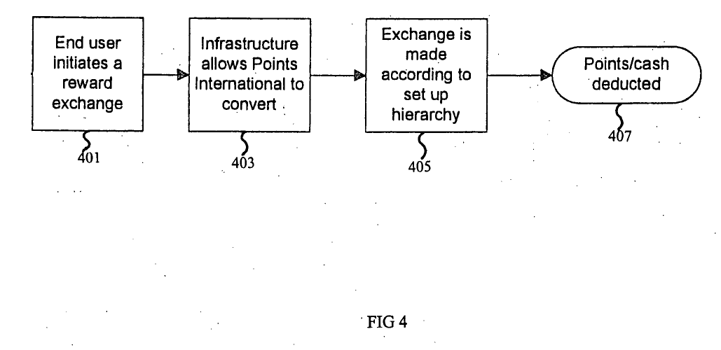

FIG. 4 is a flow chart illustrating the basic flow of events that occur when a user initiates a reward exchange using the present invention. Referring now to the steps shown in FIG. 4, in step S401, when a user initiates a reward exchange, points are converted to the appropriate currency (step S403) and, according to the user set-up and priority selections, the reward points are exchanged (step S405), as discussed above. At step S407, points and/or cash are deducted from the balance of the rewards credit card. The new balance is stored to the rewards credit card (and in the database associated with the user).

The systems, processes and components set forth in the present description may be implemented using one or more general purpose computers, microprocessors or the like, programmed according to the teachings of the present specification, as will be appreciated by those skilled in the relevant art(s). Appropriate software coding can readily be prepared by skilled programmers based on the teachings of the present disclosure, as will be apparent to those skilled in the relevant art(s). The present invention thus also includes a computer-based product which may be hosted on a storage medium and include instructions that can be used to program a computer to perform a process in accordance with the present invention. The storage medium can include, but is not limited to, any type of disk including a floppy disk, optical disk, CDROM, magneto-optical disk, ROMs, RAMs, EPROMs, EEPROMs, flash memory, magnetic or optical cards, or any type of media suitable for storing electronic instructions, either locally or remotely.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

While a preferred embodiment of the present invention has been described above, it should be understood that it has been presented by way of example only, and not limitation. Thus, the breadth and scope of the present invention should not be limited by the above described exemplary embodiment.

Obviously, numerous modifications and variations of the present invention are possible in light of the above teachings. It is therefore to be understood that the invention may be practiced otherwise than as specifically described herein.

What is claimed:

1. A loyalty and redemption method, comprising the steps of:
providing a selectable connection to a loyalty program hosting server site on a distributed communication network from a merchant site on said network whereby a customer can access said loyalty program hosting server site through said merchant site;
providing at said loyalty program hosting server site a user interface page that enables the customer to enroll and prioritize reward programs, said loyalty program hosting server site calculating a conversion value for the enrolled reward programs and a total currency value;
providing the customer with a rewards card including the calculated currency value; and
deducting currency value from said rewards card based on the prioritized reward programs.

2. The method of claim 1, wherein said user interface page further enables the customer to link at least one of a credit card, checking account and savings account to said rewards card.

3. The method of claim 1, wherein said loyalty program hosting server site prioritizes said reward programs in accordance with a predetermined variable and a best value variable.

4. The method of claim 3, wherein said predetermined variable is a redemption category.

5. The method of claim 4, wherein said redemption category is at least one of air, hotel, travel packages, rental cars, merchandise, gift certificates and cash.

6. The method of claim 1, wherein the customer prioritizes said reward programs and selects the order in which issued reward points will be used.

7. A loyalty and redemption system, comprising:
one or more merchant servers including a communication server module for communication over a distributed communication network;
one or more client-user devices including a client application module for communication over said network, said client application module interfacing with said communication server module over said network;
a loyalty program hosting server operatively connected to said network and adapted to be accessed by said client-user device via said merchant server; and
said loyalty program hosting server containing a user interface page that enables the customer to enroll and prioritize reward programs, said loyalty program hosting server being further adapted to calculate a conversion value for the enrolled reward programs and a total currency value,
wherein, after the customer enrolls using the user interface page, the customer is provided a rewards card including the calculated currency value, and the loyalty program hosting server is adapted to deduct currency value from said rewards card based on the prioritized reward programs.

8. The system of claim 7, wherein said network is at least one of the Internet, wide-area network, Intranet, public network and private network.

9. A loyalty and redemption system, comprising:
a loyalty program hosting server operatively connected to a distributed communication network, wherein said client-user device accesses said loyalty program hosting server via said merchant server; and
said loyalty program hosting server containing a user interface page that enables the customer to enroll and prioritize reward programs, said loyalty program hosting server calculating a conversion value for the enrolled reward programs and a total currency value.

10. The system of claim 9, wherein said network is at least one of the Internet, wide-area network, Intranet, public network and private network.
